(19) United States
(12) Patent Application Publication
(10) Pub. No.: US 2014/0011502 A1
(43) Pub. Date: Jan. 9, 2014

(54) Enhanced Mobility Control in Heterogeneous Networks

(71) Applicants: Jani Matti Johannes Moilanen, Helsinki (FI); Klaus Ingemann Pedersen, Aalborg (DK)

(72) Inventors: Jani Matti Johannes Moilanen, Helsinki (FI); Klaus Ingemann Pedersen, Aalborg (DK)

(73) Assignee: Nokia Siemens Networks OY, Espoo (FI)

(21) Appl. No.: 13/990,957

(22) PCT Filed: Dec. 3, 2010
(86) PCT No.: PCT/EP10/68877

§ 371 Date: Sep. 20, 2013

(51) Int. Cl. H04W 36/24

(52) U.S. Cl. CPC H04W 36/245
USPC 455/437

(57) ABSTRACT

It is provided a method, including selecting one or more candidate cells for at least one of handover, cell selection, cell reselection, and initial connection setup out of a plurality of unclassified cells of a cellular communication network, wherein the plurality of unclassified cells does not include a gray cell of the cellular communication network; determining whether at least one of the unclassified cells is acceptable for the at least one of handover, cell selection, cell reselection, and initial connection setup; and, if none of the unclassified cells is acceptable for the at least one of handover, cell selection, cell reselection, and initial connection setup, choosing the gray cell as the candidate cell.

### FIELD OF THE INVENTION

The present invention relates to mobility in heterogeneous network environments.

### BACKGROUND OF THE INVENTION

In the development of radio communication systems, in particular cellular communication (like for example GSM (Global System for Mobile Communication), GPRS (General Packet Radio Service), HSPA (High Speed Packet Access), UMTS (Universal Mobile Telecommunication System) or the like), efforts are made for an evolution of the radio access part thereof. In this regard, the evolution of radio access networks (like for example the GSM EDGE radio access network (GERAN) and the Universal Terrestrial Radio Access Network (UTRAN) or the like) is currently addressed. Such improved radio access networks are sometimes denoted as evolved or advanced radio access networks (like for example the Evolved Universal Terrestrial Radio Access Network (E-UTRAN)) or as being part of a long-term evolution (LTE) or LTE-Advanced, also generally referred to as International Mobile Communications-Advanced (IMT-A). Although such denominations primarily stem from 3GPP (Third Generation Partnership Project) terminology, the usage thereof hereinafter does not limit the respective description to 3GPP technology, but generally refers to any kind of radio access evolution irrespective of the underlying system architecture.

In the following, for the sake of intelligibility, LTE (Long-Term Evolution according to 3GPP terminology) or LTE-Advanced is taken as a non-limiting example for a radio access network of cellular type being applicable in the context of the present invention and its embodiments. However, it is to be noted that any kind of radio access network of cellular type, such as GSM, GPRS, HSPA and/or UMTS, may likewise be applicable, as long as it exhibits comparable features and characteristics as described hereinafter.

In the development of cellular systems in general, and access networks in particular, heterogeneous network environments, also referred to as multi-layer cellular network systems, comprising a combination of macrocells and microcells (also referred to as picocells or femtocells) are proposed as one concept. Thereby, the macrocells (having high transmit power) typically provide for a large geographical coverage, while the microcells (having low transmit power) typically provide for additional capacity of low geographical coverage in areas with a high user deployment. In the context of LTE or LTE-Advanced, the macrocells are typically deployed by base stations deployed as eNBs, while microcells are typically deployed as eNBs or home base stations denoted as HeNBs. Additional options for lower layer deployments are pico and femto cells. Such heterogeneous network environment may, thus, be considered to be composed at least of two network layers, i.e. a microcell layer and an overlay macrocell layer.

The two network layers of a heterogeneous network environment, i.e. the base stations and/or cells of the two network layers, may be implemented by the same or different radio access technologies. For example, a heterogeneous network environment may be composed of a GSM-based macrocell layer and a LTE-based microcell layer.

FIG. 1 shows a schematic diagram of a deployment scenario of a heterogeneous network environment comprising a combination of macrocells and microcells. In FIG. 1, macrocells are illustrated by hexagonal blocks, while microcells are illustrated by rectangular blocks. In the dashed circle, an enlarged view of a microcell including a microcell base station and a user equipment is illustrated.

Multi-layer or heterogeneous (e.g. LTE-based) networks might be deployed using co-channel deployment, dedicate carrier deployment, or a combination of those. In co-channel deployment, both the macro and micro base stations are using the same carrier frequency. In dedicate carrier deployment, macro and micro base stations are using different carrier frequencies.

Irrespective of the deployment scenario, efficient mobility techniques are to be ensured in any multi-layer or heterogeneous (e.g. LTE-based) networks, such as in any cellular communication network. In this regard, in multi-layer or heterogeneous (e.g. LTE-based) networks, a particular aspect is to reduce or even avoid any (in particular, numerous) reselections of cells in handover cell selection. In particular, any reselection between cells of different network layers during a handover procedure is detrimental to the efficiency of mobility.

Accordingly, it is desirable to have a mechanism where, during handover procedures, terminals (also referred to as user equipments UEs) moving with high speed are kept at the macro layer (i.e. are continued to be served by macrocells or macro base stations) to avoid a larger number of cell reselections, which would otherwise be experienced in case the terminal moving with high speed travels through, and is served by many microcells (i.e. by frequently changing micro base stations). On the other hand, terminals moving with lower speed should preferably be allowed to also be served by microcells or micro base station.

In this regard, current standards, e.g. current 3GPP Rel-9 LTE specifications, include a number of control aggregates that can be used in view of the above issue.

For example, it is known to estimate the speed of the different terminals at the network side, particularly at the base station, such as an eNB/HeNB, serving these different terminals. This may be accomplished by monitoring the so-called UE history information that is communicated over the X2 interface.

For example, it is known that so-called blacklists can be provided to prevent a terminal from reselections to specific intra- and inter-frequency neighboring cells.

In detail, 3GPP Rel-9 LTE specifications includes control aggregates that can be used to implement solutions where some specific UEs are prevented from being served on certain cells (e.g. the small base station layer) such as:
In 3GPP technical specification (TS) 36.300, the following is stated “Black lists can be provided to prevent the UE from reselecting to specific intra- and inter-frequency neighbouring cells”.
3GPP TS 36.331 defines separate blacklists for UE in RRC_Idle state within SIB4 & SIB5 and for UE in RRC_Connected state within measurement configuration.

Furthermore, a solution is proposed which ensures that high velocity UEs are kept at the macro layer, while other UEs also are allowed to select the small base station layer. Basically, this solution comprises the following components:
Each UE is configured with one, or multiple black lists.
Based on the autonomous UE speed estimate based on the number of experienced cell reselections (as described in 3GPP TS 36.304) in RRC_Idle or handovers in RRC_Connected state, the UE decides whether to use one of the black lists. The cells of the blacklist are excluded from handover selection.
According to one realization of the solution, one black list is employed, which is used if the UE speed is above a certain threshold; the threshold could be fixed, or be made configurable by the network.
According to another realization, several black lists could be loaded to the UEs, each corresponding to a certain speed interval, which may be fixed or configurable by the network.
According to still another realization, one blacklist may be provided to the UE which has several speed dependent entries.

As another way of restricting access of a terminal to certain cells only, HeNB's are known, which provide one of three kinds of access:
closed access: access is only allowed for subscribed users;
open access: all users are allowed to access the HeNB;
hybrid access: all users may access the cell, but subscribed users are prioritized.

The above mentioned prior-art provides tools to prevent UEs with certain characteristics (e.g. velocity, subscription type etc.) of being served on certain cells (or entire layer) in a heterogeneous network, but as a drawback it may introduce so-called coverage holes for scenarios with co-channel deployment of macro and micro/pico base stations.

For example, a so-called coverage hole may occur if a UE served by the macro-layer is moving closer to a transmitting micro/pico node, while not being allowed to connect to the small BTS node. In worst case, the interference from the small BTS will overshadow the signalling for the macro-layer received by the UE, and thus eventually result in a dropped call, i.e. a coverage hole is created around small BTS nodes.

In another example, a coverage hole may be caused by a HeNB with closed or hybrid access to which a terminal may not access although its signal overshadows the signal of the macro layer eNBs.

In a more general sense, a coverage hole may be defined as a region where a certain minimum service level can not be provided at a given time (e.g. due to low signal level, high interference, or high cell load).

### SUMMARY OF EMBODIMENTS OF THE INVENTION

The present invention and its embodiments aim at solving the above problems.

The present invention and its embodiments are made to avoid coverage holes in networks, wherein access to certain base station is restricted. Thus, the quality of a connection may be improved and call drops may be reduced or avoided. The mechanism is particularly effective in heterogeneous networks.

According to a first aspect of the present invention, there is provided a method comprising selecting one or more candidate cells for at least one of handover, cell selection, cell reselection, and initial connection setup out of a plurality of unclassified cells of a cellular communication network, wherein the plurality of unclassified cells does not comprise a gray cell of the cellular communication network; determining whether at least one of the unclassified cells is acceptable for the at least one of handover, cell selection, cell reselection, and initial connection setup; and, if none of the unclassified cells is acceptable for the at least one of handover, cell selection, cell reselection, and initial connection setup, choosing the gray cell as the candidate cell.

The method may be a method of at least one of handover, cell selection, cell reselection, and initial connection setup.

The method may further comprise classifying a cell of the communication network as a gray cell if a condition is fulfilled.

The method may be operable at a terminal of the cellular communication network.

In the method, the condition may be based on one of a speed of the terminal and a subscription of the terminal, or a combination thereof.

The method may further comprise determining whether the gray cell is acceptable for the at least one of handover, cell selection, cell reselection, and initial connection setup, and the gray cell may be only chosen as the candidate cell if it is acceptable for the at least one of handover, cell selection, cell reselection, and initial connection setup.

In the method, the determining may comprise measuring at least one of a signal quality, a power level, and a quality of service received from the respective unclassified or gray cell, and the respective unclassified or gray cell may be acceptable for the at least one of handover, cell selection, cell reselection, and initial connection setup if at least one of the measured signal quality is above a respective signal quality threshold, the measured power level is above a respective power level threshold, and the measured quality of service is above a respective quality of service threshold.

In the method, the signal quality threshold may be higher for the gray cell than for an unclassified cell; and/or wherein the power level threshold may be higher for the gray cell than for an unclassified cell; and/or wherein the quality of service threshold may be higher for the gray cell than for an unclassified cell.

The method may further comprise at least one of receiving an identification of the gray cell from the network, wherein the identification may be comprised in a system information block or in a dedicated signaling; receiving an information of the condition from the network; receiving at least one of the respective signal quality threshold, the power level threshold, and the quality of service threshold from the network; and, if the terminal is in a state in which the at least one of handover, cell selection, cell reselection, and initial connection setup is controlled by the network, signaling the chosen gray cell to the network.

The method may further comprise storing identifications of more than one gray cells in a gray list; and identifying a most acceptable cell for the at least one of handover, cell selection, cell reselection, and initial connection setup among the gray cells based on the determining for respective ones of the gray cells; wherein the most acceptable cell may be chosen as the candidate cell.

In the method, the choosing may be adapted not to choose a black cell of the cellular communication network as the candidate cell even if none of the unclassified cells is acceptable for the at least one of handover, cell selection, cell reselection, and initial connection setup, and the plurality of unclassified cells may not comprise the black cell.

According to a second aspect of the invention, there is provided a method, comprising identifying a gray list comprising an identification of one or more cells of a network to which at least one of handover, cell selection, cell reselection, and initial connection setup of a terminal is preferably avoided; and signaling the gray list from the network to the terminal.

The method may be a method of controlling at least one of handover, cell selection, cell reselection, and initial connection setup.

In the method, the signaling may comprise signaling of a threshold value below which or above which the at least one of handover, cell selection, cell reselection, and initial connection setup to the gray cell is forbidden.

In the method, the signaling may be performed with a broadcast message and/or wherein the signaling may be performed by dedicated signaling to the terminal.

In the method, the network may be a heterogeneous network comprising at least a macrocell layer and a microcell layer, and the identifying may be adapted to identify a cell of the microcell layer as a cell to which the at least one of handover, cell selection, cell reselection, and initial connection setup is preferably avoided.

According to a third aspect of the invention, there is provided an apparatus, comprising selecting processor adapted to select one or more candidate cells for at least one of handover, cell selection, cell reselection, and initial connection setup out of a plurality of unclassified cells of a cellular communication network, wherein the plurality of unclassified cells does not comprise a gray cell of the cellular communication network; determining processor adapted to determine whether at least one of the unclassified cells is acceptable for the at least one of handover, cell selection, cell reselection, and initial connection setup; and, choosing processor adapted to choose the gray cell as the candidate cell if none of the unclassified cells is acceptable for the at least one of handover, cell selection, cell reselection, and initial connection setup.

The apparatus may further comprise classifying processor adapted to classify a cell of the communication network as a gray cell if a condition is fulfilled.

In the apparatus, the condition may be based on one of a speed of the apparatus and a subscription of the apparatus, or a combination thereof.

The apparatus may further comprise determining processor adapted to determine whether the gray cell is acceptable for the at least one of handover, cell selection, cell reselection, and initial connection setup, and the choosing processor may be adapted to choose the gray cell only as the candidate cell if it is acceptable for the at least one of handover, cell selection, cell reselection, and initial connection setup.

In the apparatus, the determining processor may be adapted to measure at least one of a signal quality, a power level, and a quality of service received from the respective unclassified or gray cell, and to determine the respective unclassified or gray cell as acceptable for the at least one of handover, cell selection, cell reselection, and initial connection setup if at least one of the measured signal quality is above a respective signal quality threshold, the measured power level is above a respective power level threshold, and the measured quality of service is above a respective quality of service threshold.

In the apparatus, the signal quality threshold may be higher for the gray cell than for an unclassified cell; and/or the power level threshold may be higher for the gray cell than for an unclassified cell; and/or the quality of service threshold may be higher for the gray cell than for an unclassified cell.

The apparatus may further comprise at least one of a receiving processor adapted to receive at least one of an identification of the gray cell from the network, wherein the identification may be comprised in a system information block or in a dedicated signaling; an information of the condition from the network; at least one of the respective signal quality threshold, the power level threshold, and the quality of service threshold from the network; and a signaling processor adapted to signal the chosen gray cell to the network if the terminal is in a state in which the at least one of handover, cell selection, cell reselection, and initial connection setup is controlled by the network.

The apparatus may further comprise storing means adapted to store identifications of more than one gray cell in a gray list; and identifying means adapted to identify a most acceptable cell for the at least one of handover, cell selection, cell reselection, and initial connection setup among the gray cells based on a result of the determining means for respective ones of the gray cells; and the choosing processor may be adapted to choose the most acceptable cell as the candidate cell.

In the apparatus, the choosing processor may be adapted not to choose a black cell of the cellular communication network as the candidate cell even if none of the unclassified cells is acceptable for the at least one of handover, cell selection, cell reselection, and initial connection setup, and the plurality of unclassified cells may not comprise the black cell.

According to a fourth aspect of the invention, there is provided an apparatus, comprising selecting means adapted to select one or more candidate cells for at least one of handover, cell selection, cell reselection, and initial connection setup out of a plurality of unclassified cells of a cellular communication network, wherein the plurality of unclassified cells does not comprise a gray cell of the cellular communication network; determining means adapted to determine whether at least one of the unclassified cells is acceptable for the at least one of handover, cell selection, cell reselection, and initial connection setup; and, choosing means adapted to choose the gray cell as the candidate cell if none of the unclassified cells is acceptable for the at least one of handover, cell selection, cell reselection, and initial connection setup.

The apparatus may further comprise classifying means adapted to classify a cell of the communication network as a gray cell if a condition is fulfilled.

In the apparatus, the condition may be based on one of a speed of the apparatus and a subscription of the apparatus, or a combination thereof.

The apparatus may further comprise determining means adapted to determine whether the gray cell is acceptable for the at least one of handover, cell selection, cell reselection, and initial connection setup, and the choosing means may be adapted to choose the gray cell only as the candidate cell if it is acceptable for the at least one of handover, cell selection, cell reselection, and initial connection setup.

In the apparatus, the determining means may be adapted to measure at least one of a signal quality, a power level, and a quality of service received from the respective unclassified or gray cell, and to determine the respective unclassified or gray cell as acceptable for the at least one of handover, cell selection, cell reselection, and initial connection setup if at least one of the measured signal quality is above a respective signal quality threshold, the measured power level is above a respective power level threshold, and the measured quality of service is above a respective quality of service threshold.

In the apparatus, the signal quality threshold may be higher for the gray cell than for an unclassified cell; and/or the power level threshold may be higher for the gray cell than for an unclassified cell; and/or the quality of service threshold may be higher for the gray cell than for an unclassified cell.

The apparatus may further comprise at least one of a receiving means adapted to receive at least one of an identification of the gray cell from the network, wherein the identification may be comprised in a system information block or in a dedicated signaling; an information of the condition from the network; at least one of the respective signal quality threshold, the power level threshold, and the quality of service threshold from the network; and a signaling means adapted to signal the chosen gray cell to the network if the terminal is in a state in which the at least one of handover, cell selection, cell reselection, and initial connection setup is controlled by the network.

The apparatus may further comprise storing means adapted to store identifications of more than one gray cell in a gray list; and identifying means adapted to identify a most acceptable cell for the at least one of handover, cell selection, cell reselection, and initial connection setup among the gray cells based on a result of the determining means for respective ones of the gray cells; and the choosing means may be adapted to choose the most acceptable cell as the candidate cell.

In the apparatus, the choosing means may be adapted not to choose a black cell of the cellular communication network as the candidate cell even if none of the unclassified cells is acceptable for the at least one of handover, cell selection, cell reselection, and initial connection setup, and the plurality of unclassified cells may not comprise the black cell.

According to a fifth aspect of the invention, there is provided a terminal, comprising an apparatus according to the third or fourth aspect, wherein the terminal is attachable to the cellular communication network.

According to a sixth aspect of the invention, there is provided an apparatus, comprising identifying processor adapted to identify a gray list comprising an identification of one or more cells of a network to which at least one of handover, cell selection, cell reselection, and initial connection setup of a terminal is preferably avoided; and signaling processor adapted to signal the gray list from the network to the terminal.

In the apparatus, the signaling processor may be further adapted to signal a threshold value below which or above which the at least one of handover, cell selection, cell reselection, and initial connection setup to the gray cell is forbidden.

In the apparatus, the signaling processor may be adapted to perform the signaling with a broadcast message and/or by dedicated signaling to the terminal.

In the apparatus, the network may be a heterogeneous network comprising at least a macrocell layer and a microcell layer, and the identifying processor may be adapted to identify a cell of the microcell layer as a cell to which the at least one of handover, cell selection, cell reselection, and initial connection setup is preferably avoided.

According to a seventh aspect of the invention, there is provided an apparatus, comprising identifying means adapted to identify a gray list comprising an identification of one or more cells of a network to which at least one of handover, cell selection, cell reselection, and initial connection setup of a terminal is preferably avoided; and signaling means adapted to signal the gray list from the network to the terminal.

In the apparatus, the signaling means may be further adapted to signal a threshold value below which or above which the at least one of handover, cell selection, cell reselection, and initial connection setup to the gray cell is forbidden.

In the apparatus, the signaling means may be adapted to perform the signaling with a broadcast message and/or by dedicated signaling to the terminal.

In the apparatus, the network may be a heterogeneous network comprising at least a macrocell layer and a microcell layer, and the identifying means may be adapted to identify a cell of the microcell layer as a cell to which the at least one of handover, cell selection, cell reselection, and initial connection setup is preferably avoided.

According to an eighth aspect of the invention, there is provided a network element, comprising an apparatus according to any of the sixth and seventh aspects, wherein the network element is connectable to the network.

According to a ninth aspect of the invention, there is provided a computer program product including a program comprising software code portions being arranged, when run on a processor of an apparatus, to perform the method according to any one of the first and second aspects.

The computer program product may comprise a computer-readable medium on which the software code portions are stored, and/or wherein the program is directly loadable into a memory of the processor.

By way of exemplary embodiments of the present invention, there are provided mechanisms for mobility in heterogeneous networks, which may efficiently eliminate or at least reduce coverage holes which may lead to poor connection quality or even call drops.

### BRIEF DESCRIPTION OF THE DRAWINGS

In the following, the present invention will be described in greater detail by way of non-limiting examples with reference to the accompanying drawings, in which

FIG. 1 shows an exemplary illustration of a deployment scenario of a heterogeneous network environment comprising a combination of macrocells and microcells;

FIG. 2 shows an apparatus according to exemplary embodiments of the present invention;

FIG. 3 shows a method according to exemplary embodiments of the present invention;

FIG. 4 shows another apparatus according to exemplary embodiments of the present invention; and

FIG. 5 shows another method according to exemplary embodiments of the present invention.

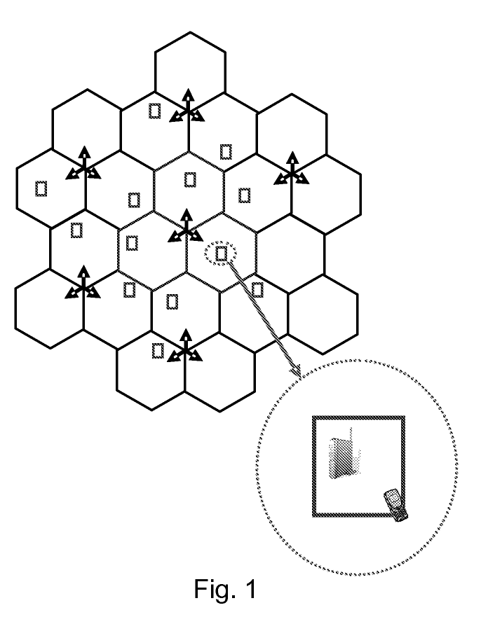

### DETAILED DESCRIPTION OF EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

Preferably, the present invention and its embodiments relate to mobility in multi-layer cellular systems also referred to as heterogeneous networks. As described above, in this context, multi-layer networks refer to cases with a mixture of macro cells/base stations as well as micro cells/base stations. As an example, multi-layer LTE networks are particularly referred to herein, while the present invention and its embodiments could equally be applied to other cellular standards as well. Macro layer and micro layer may be implemented in the same or different radio access technologies RAT (for example, the macro layer could be implemented in GSM RAT and the micro layer could be implements in LTE RAT). In LTE/LTE-Advanced, cells of the lower layer may comprise e.g. microcells of eNBs or HeNBs, pico-cells, and femto-cells. In HSPA/UMTS, embodiments of the present invention are preferably applicable to pico-/femtocells as smaller cells.

In particular, the present invention and its embodiments are mainly described in relation to 3GPP specifications being used as non-limiting examples for certain exemplary network configurations and deployments. In particular, an LTE/LTE-A network environment is used as a non-limiting example for the applicability of thus described exemplary embodiments. Rather, any other network configuration or system deployment comprising a restriction of access to certain cells for a terminal, e.g. by means of one or more blacklists, a HeNB with closed access or hybrid access, or a restriction dependent on the terminal's speed, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

In the following, exemplary embodiments of the present invention are described with reference to methods, procedures and functions.

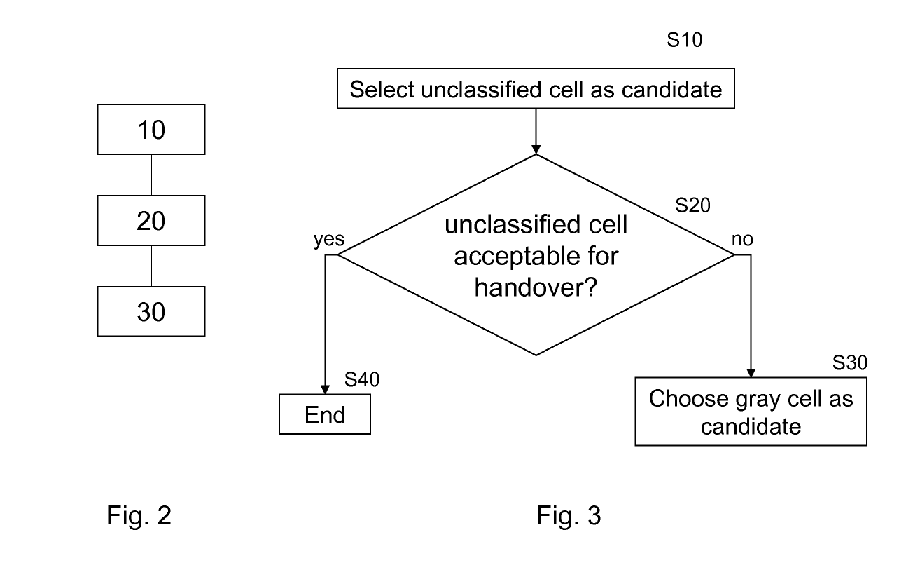

FIG. 2 shows an apparatus according to an embodiment of the invention. The apparatus may be a terminal such as a user equipment (UE). It comprises a selecting processor 10, a determining processor 20, and a choosing processor 30.

FIG. 3 shows a method according to an embodiment of the invention. The way of functioning of the apparatus of FIG. 2 is explained hereinafter with reference to the method of FIG. 3. However, the apparatus is not limited to performing the method of FIG. 3, and the method is not limited to being performed by the apparatus of FIG. 2.

In step S10, the selecting processor 10 may select one or more cells of the network as potential candidates for handover. The selecting is restricted to unclassified cells which are cells that are not marked as gray cells. According to some embodiments, the selecting may be additionally restricted to such cells that are not marked as black cells. That is, unclassified cells in these embodiments are cells that are neither marked as gray cell nor marked as black cell.

Gray cells are cells to which a handover is preferably avoided. Black cells are cells to which a handover is forbidden. Some embodiments may comprise gray cells but no black cells, while other embodiments may comprise gray cells and black cells.

For example, the gray cells or black cells may be comprised in a gray list and black list, respectively. In some embodiments, the gray list or black list may be provided from the network to the terminal. Thus, it/they may be kept up-to-date, and the terminal has to store and handle only gray lists and/or black lists which may be actually relevant. In other embodiments, the gray list or black list may be predefined in the terminal, thus reducing load on the network.

In some embodiments, alternatively to a gray list and/or a black list, a cell may be marked in another stored record of the cell as a gray cell or black cell by a corresponding flag.

In another example, whether a cell is a gray cell or black cell may be determined based on a speed of the terminal. E.g. access to a lower layer in a heterogeneous network may be preferably avoided (gray cell) or even forbidden (black cell) for a fast terminal. In still another example, if the apparatus is not subscribed to a HeNB, a black cell may be a cell of the HeNB that only allows for closed access, and a gray cell may be a cell of the HeNB allowing for hybrid access.

A cell may be a gray cell or a black cell under certain conditions only. For example, this may depend on the speed of the terminal. If the terminal is slow, it may access to all cells (all cells are unclassified), while, if it is faster, access to some cells such as smaller cells in a heterogeneous network may be preferably avoided (gray cells), while, if it is very fast, access to some or all of the smaller cells may be forbidden (black cells).

The condition for a cell being a gray cell or being a black cell may be the same. I.e. every gray cell may be a black cell, too. In other embodiments, the condition for a cell being a black cell may be stricter than for a cell being a gray cell. In these embodiments, the black cells may be a subset of the gray cells.

In some embodiments, the terminal may receive information on the conditions from the network, e.g. by a corresponding instruction. In other embodiments, the identifications of the black lists and/or the information on conditions may be predefined.

In step S20, it may be determined if one of the unclassified cells selected as candidates for handover in step S10 is acceptable for handover. Step S20 may be performed by determining processor 20. The determination may be based e.g. on signal quality or power level. One or both of these parameters may be measured by the terminal and compared with respective thresholds. A cell may be acceptable for handover, if at least one of the signal quality and power level is above its respective threshold. In some embodiments, for being acceptable, it may be required that both of these parameters are above the respective threshold. In some embodiments, other parameters may be evaluated in addition or instead of signal quality and power level.

If one of the selected cell candidates is acceptable for handover, the method ends (step S40). Then, for example, handover to this cell candidate may be performed, or the terminal or the network may decide for some other reasons not to perform a handover to this candidate cell.

If none of the selected cell candidates of the unclassified cells is acceptable for handover, a gray cell may be chosen as handover candidate cell (step S30). This step may be performed by choosing processor 30. Then, for example, handover to the gray cell may be performed, or the terminal or the network may decide for some other reasons not to perform a handover to the gray cell.

For example, before handover is performed to a gray cell, it may be determined if the gray cell is acceptable for handover. This determination may be done in a corresponding or similar way as according to step S20 described for the unclassified candidate cells. In particular, in some embodiments, the threshold values for gray cells may be higher than the corresponding ones for the unclassified cells. Thus, a fast sequence of handovers from/to the gray cell (“ping-pong”) may be avoided.

In some embodiments, the threshold values may be received from the network. In others, the threshold values may be predefined.

Furthermore, if there is more than one gray cell, e.g. several gray cells on a gray list, the terminal may determine which of the gray cells is most acceptable for handover. For example, it may determine which one has the highest signal quality or highest power level. It may also determine a parameter which is based on a combination of the signal quality and power level, and decide which of the gray cells has the highest (or lowest) value of this combined parameter.

In the following, some details are given with respect to the gray list:

The gray list may contain a list of cells that the terminal such as a user equipment (UE) may preferably avoid to connect to (or camp on). Thus, for example, if gray cells are determined based on the speed of the terminal, the gray list for high speed UEs may basically contain small BTS nodes (e.g. micro and pico cells).

In some embodiments, the terminal shall still perform measurements of signal quality and/or power level for cells in the gray-list but not for cells only in the black list. In other embodiments, measurements are performed for cells in the black list, too. In still other embodiments, measurements are not performed for any cell in the gray list and—if available—the black list, except when a handover to a cell in the gray list may be required because no acceptable unclassified cell was identified. In this case, in some embodiments, measurements may be performed for cells in the gray list only, or for cells in the gray list and for cells in the black list.

In some embodiments, only if the UE is experiencing signal level, signal quality, and/or quality of service below a first threshold for its current serving cell and cells outside the gray list (unclassified cells), the UE is allowed to trigger handover events to cells on the gray list. The latter happens only if the signal level, signal quality, and/or quality of service of the gray listed cell(s) is above a second threshold. This second threshold may be higher or lower than the threshold for unclassified cells outside the gray list. The first and second thresholds may be parameterized. An example for a quality of service parameter is a bit rate, and the corresponding threshold is a guaranteed bit rate.

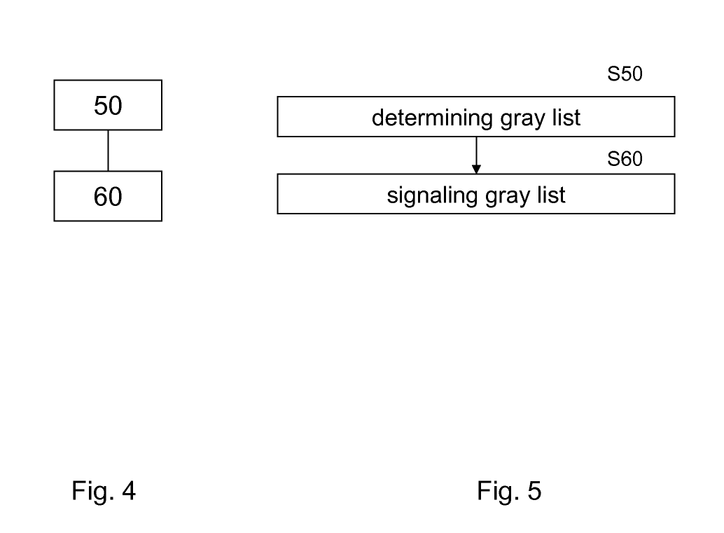

Another apparatus according to an embodiment of the invention is shown in FIG. 4, and a corresponding method is shown in FIG. 5. The apparatus according to FIG. 4 may be a network or a network entity suitable for attaching a terminal such as a user equipment (UE). However, the method is not limited to being performed by the network or network entity of FIG. 4, and the network or network entity is not limited to performing the method of FIG. 5.

The apparatus according to FIG. 4 may comprise a determining processor 50 and a signalling processor 60.

In some exemplary embodiments of the invention, in particular but not limited to a network of LTE or LTE-Advanced, the method according to FIG. 5 may comprise determining a gray list (step S50). This step may be performed by determining processor 50. For example, the network may determine small cells or HeNB with hybrid access. The cells of the gray list may be predetermined according to some embodiments.

Then, according to step S60, one or more gray lists are signalled from the network or network entity to the UE (step S60). The step may be performed by signalling processor 60.

According to some embodiments, the signalling may comprise the above mentioned threshold values. The thresholds may be defined for signal quality and/or received power level. The thresholds may be related to the current serving cell, for handover to unclassified cells, and/or for handover to gray cells. The thresholds may be applicable for UEs in idle mode and/or active mode. Each of these thresholds may be different from the others, or some or all of the thresholds may be the same.

Furthermore, according to some embodiments, the signalling may comprise conditions for classifying a cell as a gray cell or as a black cell. Preferably, a condition for a black cell is equivalent or stricter than the corresponding condition for a gray cell.

If gray lists, black lists, thresholds, and/or conditions are signalled from the network to the terminal, they may be easily kept up-to-date and may be even dynamically adapted to specific situations on the network. Furthermore, the network or network entity may transmit only those parameters that appear to be relevant for the terminal in the near future. On the other hand, if at least some of these parameters are predefined in the terminal, the load on the network may be reduced.

According to some embodiments, the signalling may be performed with broadcast messages (e.g. in system information blocks (SIBs)) and/or with dedicated signalling such as radio resource control (RRC) signalling. In the latter case, the gray lists, thresholds, and/or conditions may be terminal specific.

In some embodiments, the network or network entity transmits a black list to the terminal, which is treated by the terminal as a gray list. In detail, if the signal level or signal quality of the best allowed (unclassified) cell (in this case, unclassified cells are cells not including the black listed cells) is below a first threshold, then the UE is allowed to also perform measurements for black listed cells. Black listed cells with signal level or signal quality above a second threshold can hereafter be considered as allowed cells for handover. The first and second thresholds may be parameterized.

The embodiments of the preceding paragraph are based on a black list mechanism to which the first and second thresholds are added. Threshold values for the black lists may be set based on some general minimum signal quality or received power level requirements for the terminal, or they could be potentially optimized on terminal level (e.g. to guarantee certain level of QoS). For example, the minimum signal quality or power level may be based on the corresponding general requirements for handover according to the specific radio access technology, such as LTE or LTE-Advanced.

According to exemplarily embodiments of the present invention, a system may comprise any conceivable combination of the thus depicted apparatuses (such as one or more terminals and associated one or more network entities such as base stations or home base stations).

Some embodiments are described hereinabove with reference to an LTE network. However, in other embodiments, other cellular radio networks belonging to other radio access technologies such as but not limited to GSM, GPRS, EDGE, LTE-A, IMT may be employed. In the same embodiment, different radio technologies may be employed, e.g. for macro- and micro-cells.

Some embodiments are described herein with reference to handover. However, in some embodiments, instead of or in addition to handover the gray list may be applied to e.g. cell selection, cell reselection, and/or initial connection setup.

In general, it is to be noted that respective functional blocks or elements according to above-described aspects can be implemented by any known means, either in hardware and/or software and/or firmware, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware or firmware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

Generally, for the purpose of the present invention as described herein above, it should be noted that
method steps and functions likely to be implemented as software code portions and being run using a processor at one of the entities, a network element, or a terminal (as examples of devices, apparatuses and/or modules thereof, or as examples of entities including apparatuses and/or modules therefor), are software code independent and can be specified using any known or future developed programming language, such as e.g. Java, C++, C, and Assembler, as long as the functionality defined by the method steps is preserved;
generally, any method step is suitable to be implemented as software or by hardware without changing the idea of the invention in terms of the functionality implemented;
method steps, functions, and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

The present invention also covers any conceivable combination of method steps and operations described above, and any conceivable combination of nodes, apparatuses, modules or elements described above, as long as the above-described concepts of methodology and structural arrangement are applicable.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as defined by the appended claims.

1-30. (canceled)

31. A method, comprising
selecting one or more candidate cells for at least one of handover, cell selection, cell reselection, and initial connection setup out of a plurality of unclassified cells of a cellular communication network, wherein the plurality of unclassified cells does not comprise a gray cell of the cellular communication network;
determining whether at least one of the unclassified cells is acceptable for the at least one of handover, cell selection, cell reselection, and initial connection setup; and,
if none of the unclassified cells is acceptable for the at least one of handover, cell selection, cell reselection, and initial connection setup, choosing the gray cell as the candidate cell.

32. The method according to claim 31, further comprising classifying a cell of the communication network as a gray cell if a condition is fulfilled.

33. The method according to claim 32, wherein the method is operable at a terminal of the cellular communication network.

34. The method according to claim 33, wherein the condition is based on one of a speed of the terminal and a subscription of the terminal, or a combination thereof.

35. The method according to claim 31, further comprising
determining whether the gray cell is acceptable for the at least one of handover, cell selection, cell reselection, and initial connection setup, and wherein
the gray cell is only chosen as the candidate cell if it is acceptable for the at least one of handover, cell selection, cell reselection, and initial connection setup.

36. The method according to claim 31, wherein the determining comprises measuring at least one of a signal quality, a power level, and a quality of service received from the respective unclassified or gray cell, and wherein the respective unclassified or gray cell is acceptable for the at least one of handover, cell selection, cell reselection, and initial connection setup if at least one of the measured signal quality is above a respective signal quality threshold, the measured power level is above a respective power level threshold, and the measured quality of service is above a respective quality of service threshold.

37. The method according to claim 36, wherein the signal quality threshold is higher for the gray cell than for an unclassified cell; and/or wherein the power level threshold is higher for the gray cell than for an unclassified cell; and/or wherein the quality of service threshold is higher for the gray cell than for an unclassified cell.

38. The method according to claim 35, further comprising
storing identifications of more than one gray cells in a gray list; and
identifying a most acceptable cell for the at least one of handover, cell selection, cell reselection, and initial connection setup among the gray cells based on the determining for respective ones of the gray cells; wherein
the most acceptable cell is chosen as the candidate cell.

39. The method according to claim 31, wherein
the choosing is adapted not to choose a black cell of the cellular communication network as the candidate cell even if none of the unclassified cells is acceptable for the at least one of handover, cell selection, cell reselection, and initial connection setup, and
the plurality of unclassified cells does not comprise the black cell.

40. A method, comprising
identifying a gray list comprising an identification of one or more cells of a network to which at least one of handover, cell selection, cell reselection, and initial connection setup of a terminal is preferably avoided; and
signaling the gray list from the network to the terminal.

41. The method according to claim 40, wherein the signaling comprises signaling of a threshold value below which or above which the at least one of handover, cell selection, cell reselection, and initial connection setup to the gray cell is forbidden.

42. An apparatus, comprising
selecting processor adapted to select one or more candidate cells for at least one of handover, cell selection, cell reselection, and initial connection setup out of a plurality of unclassified cells of a cellular communication network, wherein the plurality of unclassified cells does not comprise a gray cell of the cellular communication network;
determining processor adapted to determine whether at least one of the unclassified cells is acceptable for the at least one of handover, cell selection, cell reselection, and initial connection setup; and,
choosing processor adapted to choose the gray cell as the candidate cell if none of the unclassified cells is acceptable for the at least one of handover, cell selection, cell reselection, and initial connection setup.

43. An apparatus, comprising
identifying processor adapted to identify a gray list comprising an identification of one or more cells of a network to which at least one of handover, cell selection, cell reselection, and initial connection setup of a terminal is preferably avoided; and
signaling processor adapted to signal the gray list from the network to the terminal.

44. The apparatus according to claim 43, wherein the signaling processor is further adapted to signal a threshold value below which or above which the at least one of handover, cell selection, cell reselection, and initial connection setup to the gray cell is forbidden.

45. A computer program product including a program comprising software code portions being arranged, when run on a processor of an apparatus, to perform the method according to claim 31.

46. The computer program product according to claim 45, wherein the computer program product comprises a computer-readable medium on which the software code portions are stored, and/or wherein the program is directly loadable into a memory of the processor.
